(19) United States
(12) Patent Application Publication
(10) Pub. No.: US 2025/0060010 A1
(43) Pub. Date: Feb. 20, 2025

(54) CONSTANT VELOCITY JOINT

(71) Applicant: Steering Solutions IP Holding Corporation, Saginaw, MI (US)

(72) Inventors: Jon N. Miller, Merrill, MI (US); Jeffrey P. COURVILLE, Frankenmuth, MI (US); Jenny C. Ho, Midland, MI (US); Eduardo R. MONDRAGON-PARRA, Freeland, MI (US)

(21) Appl. No.: 18/807,330

(22) Filed: Aug. 16, 2024

Related U.S. Application Data
(60) Provisional application No. 63/533,342, filed on Aug. 17, 2023.

(51) Int. Cl. F16D 3/224; F16D 3/06

(52) U.S. Cl. CPC F16D 3/224; F16D 3/06

(57) ABSTRACT

A constant velocity joint includes an inner race having inner ball tracks extending between opposite inner race sides and an outer race having outer ball tracks extending between opposite outer race sides. The inner ball tracks have an inner ball track radius of curvature extending between the inner race sides. The outer ball tracks have an outer ball track radius of curvature extending between the outer race sides. At least one inner ball track radius of curvature has a convex curvature and at least one inner ball track radius of curvature has a concave curvature, and/or, the inner ball track radius of curvature of at least one inner ball track has a radius origin offset from the central axis of rotation, and/or, the outer ball track radius of curvature of at least one outer ball track has a radius origin offset from the central axis of rotation.

### CROSS-REFERENCE TO RELATED APPLICATION

This application claims the benefit of U.S. Provisional Application Ser. No. 63/533,342, filed Aug. 17, 2023, which is incorporated herein by reference in its entirety.

### FIELD OF THE INVENTION

The present disclosure generally relates to shaft assemblies for motor vehicles, and more specifically, to constant velocity joints for shaft assemblies.

### BACKGROUND OF THE INVENTION

Constant-velocity joints (CVJ) for automotive shaft joint applications are under increased demand to have low mass, small packaging, and high mechanical efficiency. In order to increase mechanical efficiency, it is known to incorporate straight helical ball tracks, however, this typically results in an increase in package size. In order to be able to reduce the package size, reducing the helical angle can be employed, however, this generally results in an increase in clicking noise.

Accordingly, what is needed is a constant velocity joint that overcomes at least those drawbacks discussed above, while at the same time, having low mass, small packaging, and high mechanical efficiency.

### SUMMARY OF THE INVENTION

An aspect of the present disclosure provides a constant velocity joint including an inner race having opposite inner race sides with a plurality of inner rolling member tracks following an inner rolling member track helical path relative to the central axis of rotation. Each inner rolling member track having an inner rolling member track radius of curvature extending from one of the inner race sides to the other of the inner race sides. An outer race is disposed about the inner race such that the inner race and the outer race extend about a common central axis of rotation. The outer race having opposite outer race sides with a plurality of outer rolling member tracks following an outer rolling member track helical path relative to the central axis of rotation. Each outer rolling member track having an outer rolling member track radius of curvature extending from one of the outer race sides to the other of the outer race sides. The outer rolling member tracks being arranged in paired relation with the inner rolling member tracks to define a plurality of rolling member raceways. At least one rolling member is disposed in each of the rolling member raceways for rolling receipt in the inner rolling member tracks and the outer rolling member tracks. At least one inner rolling member track radius of curvature has a convex radius of curvature and the paired outer rolling member track radius of curvature has a concave radius of curvature, and at least one inner rolling member track radius of curvature has a concave radius of curvature and the paired outer rolling member track radius of curvature has a convex radius of curvature.

In accordance with a further aspect of the disclosure, a constant velocity joint is provided including an inner race and an outer race disposed about the inner race such that the inner race and the outer race extend about a common central axis of rotation. The inner race has opposite inner race sides with a plurality of inner rolling member tracks extending along a helical path relative to the central axis of rotation from one of the inner race sides to the other of the inner race sides. The outer race has opposite outer race sides with a plurality of outer rolling member tracks extending along a helical path relative to the central axis of rotation from one of the outer race sides to the other of the outer race sides. The outer rolling member tracks are arranged in paired relation with the inner rolling member tracks to define a plurality of rolling member raceways extending in helical relation to the central axis of rotation. At least one rolling member is disposed in each of the rolling member raceways for rolling receipt in the inner rolling member tracks and the outer rolling member tracks. Each of the inner rolling member tracks has an inner rolling member track radius of curvature extending from one of the inner race sides to the other of the inner race sides. Each of the outer rolling member tracks has an outer rolling member track radius of curvature extending from one of the outer race sides to the other of the outer race sides. The inner rolling member track radius of curvature of at least one of the inner rolling member tracks has an origin of radius offset from the central axis of rotation.

These and other aspects, objects, advantages and features will become readily apparent to one possessing ordinary skill in the art in view of the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1A is a cross-sectional view taken generally along a longitudinal central axis of a stroking constant velocity joint constructed in accordance with one aspect of the disclosure;

FIG. 1B is a front elevation view of the stroking constant velocity joint of FIG. 1A looking generally along the line 1B with a cage removed for clarity purposes only;

FIG. 2 is a front elevation view of an inner race of the constant velocity joint of FIG. 1 showing inner ball tracks that follow an inner ball track helical path relative to a central axis and having an inner ball track radius of curvature extending from one of the inner race sides to the other of the inner race sides;

FIG. 3A is a side view of the inner race of FIG. 2 looking generally along the direction of arrow 3A of FIG. 2;

FIG. 3B is a schematic view of a convex ball track path taken generally along the line 3B-3B of FIG. 3A of FIG. 2;

FIG. 4A is a side view of the inner race of FIG. 2 looking generally along the direction of arrow 4A of FIG. 2;

FIG. 4B is a schematic view of a concave ball track path taken generally along the line 4B-4B of FIG. 4A for the even numbered ball tracks identified in FIG. 2;

FIG. 5 is a view similar to FIG. 3B illustrating a convex ball track path having a non-constant, variable radius of curvature;

FIG. 6 is a view similar to FIG. 4B illustrating a concave ball track path having a non-constant, variable radius of curvature;

FIG. 7A is a cross-sectional view of an outer race of the constant velocity joint taken generally along the line 7A-7A of FIG. 1;

FIG. 7B is a schematic view of a concave ball track path taken generally along the line 7B-7B of FIG. 7A;

FIG. 8A is a cross-sectional view of the outer race of the constant velocity joint taken generally along the line 8A-8A of FIG. 1; and

FIG. 8B is a schematic view of a convex ball track path taken generally along the line 8B-8B of FIG. 8A.

### DETAILED DESCRIPTION

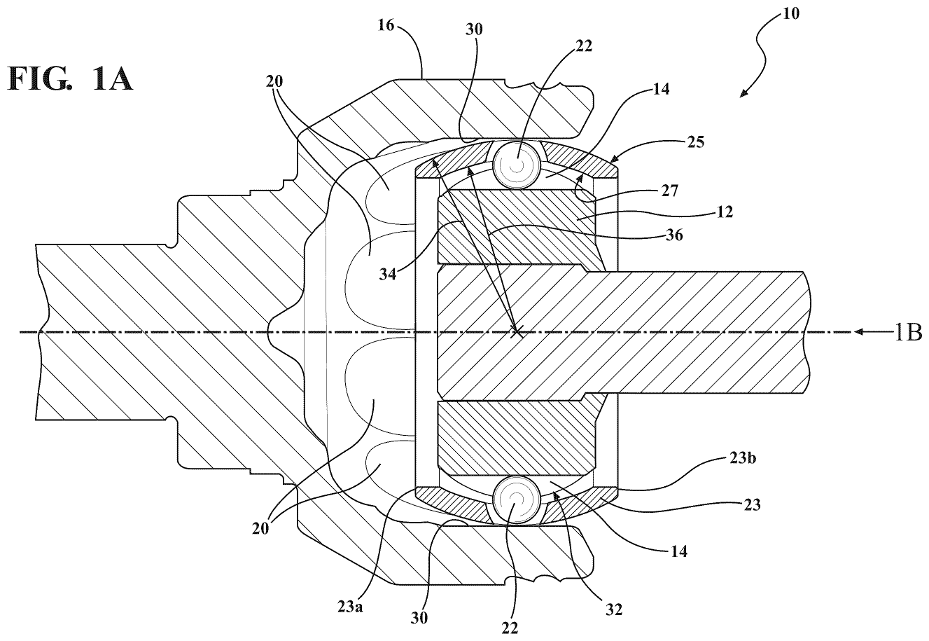

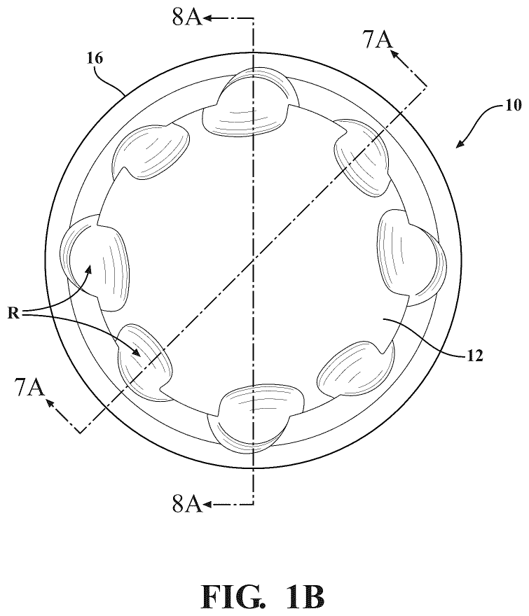

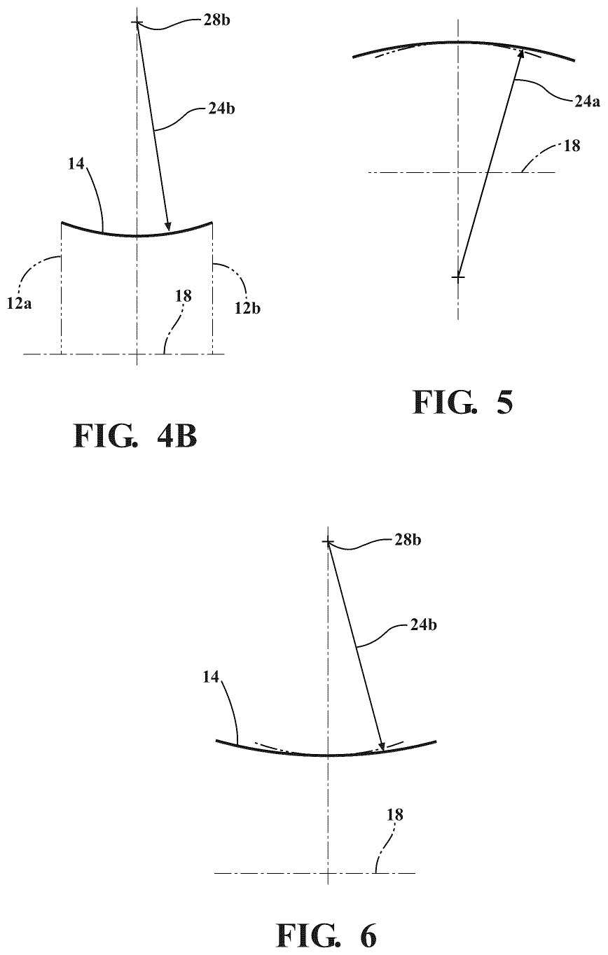

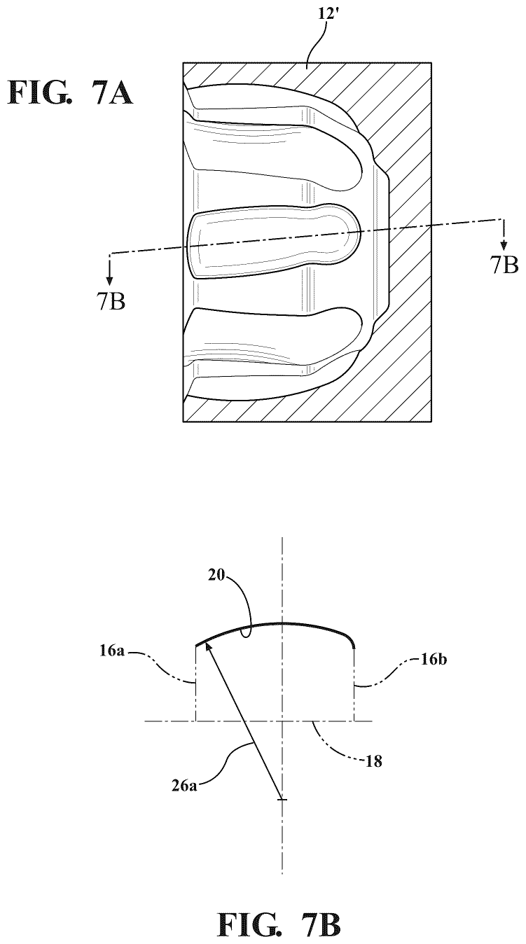

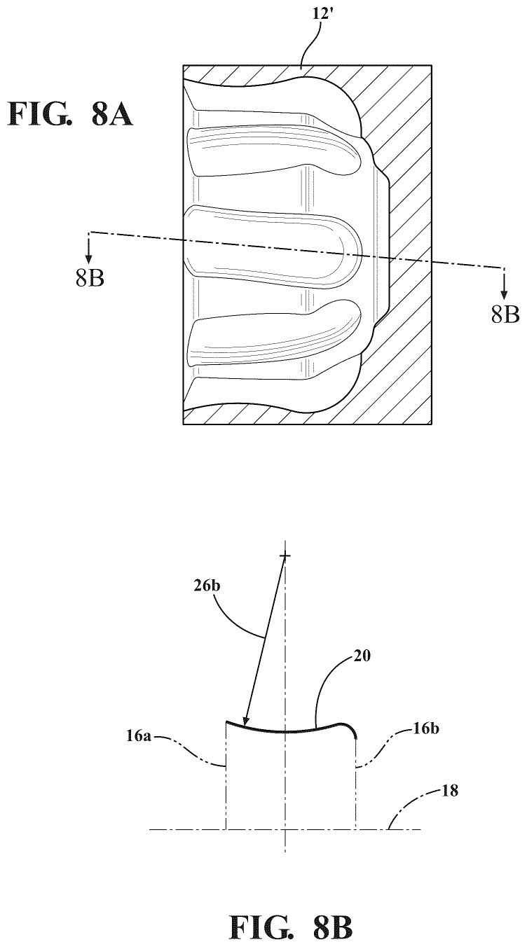

Referring now to the Figures, where the invention will be described with reference to specific embodiments, without limiting same, FIG. 1 illustrates a stroking constant velocity joint, also referred to as constant velocity joint (CVJ) 10 constructed in accordance with an aspect of the disclosure. CVJ 10 includes an inner race 12 having opposite inner race sides, also referred as inner sides 12a, 12b, with a plurality of individual inner rolling member tracks, also referred to as inner ball tracks 14, extending from one of the inner race sides 12a to the other of the inner race sides 12b. Accordingly, the inner ball tracks 14 are circumferentially spaced from one another in equidistant relation from one another about an outer periphery of the inner race 12. CVJ 10 further includes an outer race 16, wherein outer race 16 is disposed about the inner race 12 such that the inner race 12 and the outer race 16 extend about a common central axis of rotation, referred to as central axis 18. The outer race 16 has opposite outer race sides, also referred to as outer sides 16a, 16b, with a plurality of outer rolling member tracks, also referred to as outer ball tracks 20, extending from one of the outer race sides to the other of the outer race sides. Accordingly, the outer ball tracks 20 are circumferentially spaced from one another in equidistant relation from one another about an inner periphery of the outer race 16. The inner ball tracks 14 and the outer ball tracks 20 are radially aligned in matching relation, also referred to as facing or paired relation, with one another to define a plurality of rolling member raceways, referred to as raceways R, therebetween, as is known in the art. A plurality of rolling member 22, such as spherical balls, is disposed between the inner race 12 and outer race 16, with at least one rolling member 22 being positioned for rolling receipt in each raceways R defined by the inner ball tracks 14 and the outer ball tracks 20. A cage 23 (FIG. 1A) is provided to guide the rolling elements 22 in their respective inner and outer ball tracks 14, 20. Each of the inner ball tracks 14 follow an inner ball track helical path relative to the central axis 18 and have an inner ball track radius of curvature (FIGS. 3A-4B) extending from one of the inner race sides 12a to the other of the inner race sides 12b. Each of the outer ball tracks 20 follow an outer ball track helical path relative to the central axis 18 and have an outer ball track radius of curvature (FIGS. 7A-8B) extending from one of the outer race sides 16a to the other of the outer race sides 16b.

The cage 23 has a plurality of pockets, conforming to the number of rolling elements 22, sized for loose receipt of the rolling elements therein. The cage 23 has an outer surface 25 sized for receipt in a bore of the outer race 16, with the outer surface 25 sized for clearance with a generally cylindrical radially innermost cylindrical surface 30 of the outer race 16. The cage 23 has an inner surface 27 sized for clearance with a radially outermost convex surface 32 of the inner race 12. The outer and inner surfaces 25, 27 extend generally axially between opposite cage sides 23a, 23b.

In accordance with one aspect of the disclosure, as best shown in FIGS. 3A and 3B, at least one inner rolling member track radius of curvature has a convex inner rolling member track radius of curvature, also referred to as convex inner radius of curvature 24a, extending from one side 12a to the opposite side 12b, and, as best shown in FIGS. 7A and 7B, the paired outer rolling member track radius of curvature has a concave outer rolling member track radius of curvature concave, also referred to as concave outer radius of curvature 26a, extending from one side 16a to the opposite side 16b. Further, as best shown in FIGS. 4A and 4B, at least one inner rolling member track radius of curvature has a concave inner rolling member track radius of curvature, also referred to as concave inner radius of curvature 24b, extending from one side 12a to the opposite side 12b, and, as best shown in FIGS. 8A and 8B, the paired outer rolling member track radius of curvature has a convex outer rolling member track radius of curvature, also referred to as convex radius of curvature 26b.

In accordance with one aspect of the disclosure, every other inner ball track 14 can be provided having the convex inner radius of curvature 24a, with the paired outer ball track 16 having the concave outer radius of curvature 26a, and every other inner ball track 14 can be provided having the concave inner radius of curvature 24b, with the paired outer ball track 16 having the convex outer radius of curvature 26b. Accordingly, the convexity and concavity of the inner ball tracks 14 alternate with one another, the convexity and concavity of the outer ball tracks 16 alternate with one another, with convex inner ball tracks 14 being paired with concave outer ball tracks 16, and with concave inner ball tracks 14 being paired with convex outer ball tracks 16.

In accordance with another aspect of the disclosure, the inner ball track radius of curvature, whether formed as a convex inner radius of curvature 24a or a concave inner radius of curvature 24b, can be formed such that the radius forming the concave or convex curvature it is not constant, wherein a constant radius is designated in FIGS. 5 and 6 by a phantom line. Accordingly, the convex inner radius of curvature 24a (FIG. 5) and the convex inner radius of curvature 24b (FIG. 6) can follow a second order, also referred to as quadratic, a third order, or higher order polynomial mathematical function, by way of example and without limitation. Accordingly, the radius of the convex inner radius of curvature 24a (FIG. 5) and the convex inner radius of curvature 24b is not constant. Likewise, the outer ball track radius of curvature can be formed such that it is not constant, following a similar mathematical function as the inner ball track radius of curvature. The inner rolling member track radius of curvature and the outer rolling member track radius of curvature, regardless of their being constant or non-constant, can be provided being equidistantly spaced from one another along their entirety, thereby providing a uniformly sized raceway R.

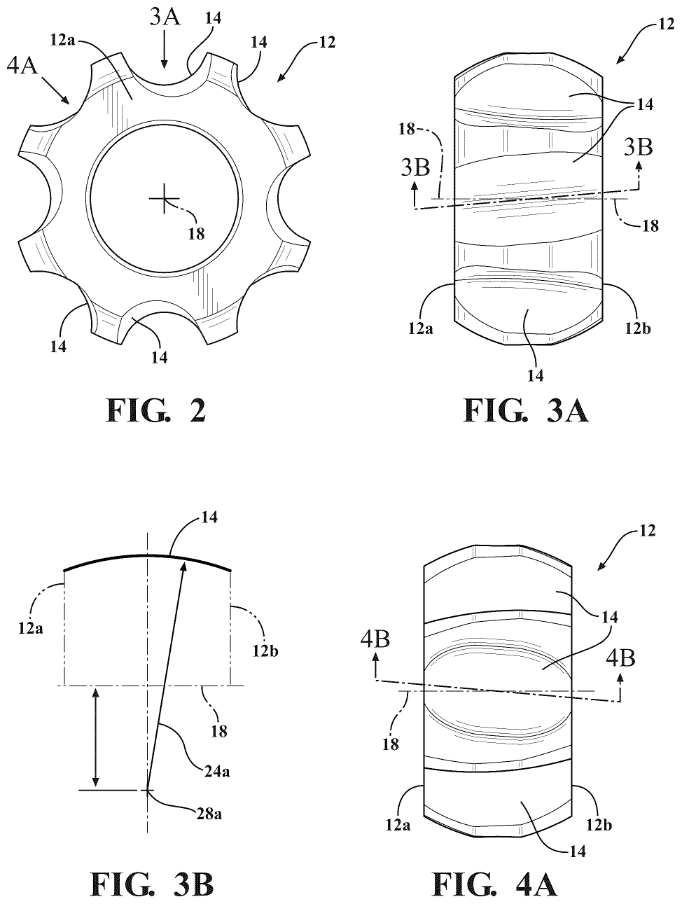

In accordance with a further aspect of the disclosure, as shown in FIG. 2, every other inner rolling member track 14 can be provided having a left helix about the central axis 18, with the outer rolling member tracks 20 paired with the left helix inner rolling member tracks 14 having a right helix about the central axis 18. Further, every other inner rolling member track 14 can be provided having a right helix about the central axis 18, with the outer rolling member tracks 20 paired with the right helix inner rolling member tracks 14 having a left helix about the central axis 18. Accordingly, where the inner ball track 14 has a left helix, the paired outer ball track 16 has a right helix, and vice versa.

In accordance with a further aspect of the disclosure, at least one of the inner rolling member track radius of curvature 24a, 24b and the outer rolling member track radius of curvature 26a, 26b has an origin of radius offset, also referred to as spaced radially, from the central axis 18. For example, as shown in FIG. 3B, an origin 28a of the convex inner radius of curvature 24a is provided in spaced relation from the central axis 18, wherein the central axis 18 is between the origin 28a and the corresponding convex inner rolling member track 14. Further, as shown in FIG. 4B, an origin 28b of the concave inner radius of curvature 24b is provided in spaced relation from the central axis 18, wherein the inner rolling member track 14 is between the origin of radius 28b thereof and the central axis 18. The offset of origins 28a, 28b can be incorporated with an inner race 12 having all convex inner radius of curvature 24a, all concave inner radius of curvature 24b, or a mix of convex and concave inner radius of curvatures 24a, 24b.

The cage outer and inner surfaces 25, 27 have respective concentric radii of curvatures 34, 36, thereby having a common origin of radius. The outer radius of curvature 34 is sized for clearance with the inner surface 30 of the outer race 16, thereby allowing for axially plunging movement of the cage 23 relative to the outer race 16, and the inner radius of curvature 36 is greater than the radius of curvature of the convex surface 32 of the inner race, thereby facilitate relative pivotal movement with the inner race 12.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Individual elements or features of a particular embodiment are generally not limited to that particular embodiment, but, where applicable, are interchangeable and can be used in a selected embodiment, even if not specifically shown or described. Accordingly, the invention is not to be seen as limited by the foregoing description.

Having thus described the invention, it is claimed:

1. A constant velocity joint, comprising:
an inner race having opposite inner race sides with a plurality of inner rolling member tracks following an inner rolling member track helical path relative to the central axis of rotation, each inner rolling member track having an inner rolling member track radius of curvature extending from one of the inner race sides to the other of the inner race sides;
an outer race disposed about the inner race such that the inner race and the outer race extend about a common central axis of rotation, the outer race having opposite outer race sides with a plurality of outer rolling member tracks following an outer rolling member track helical path relative to the central axis of rotation, each outer rolling member track having an outer rolling member track radius of curvature extending from one of the outer race sides to the other of the outer race sides, the outer rolling member tracks being arranged in paired relation with the inner rolling member tracks to define a plurality of rolling member raceways; and
at least one rolling member disposed in each of the rolling member raceways for rolling receipt in the inner rolling member tracks and the outer rolling member tracks,
wherein at least one inner rolling member track radius of curvature has a convex radius of curvature and the paired outer rolling member track radius of curvature has a concave radius of curvature,
wherein at least one inner rolling member track radius of curvature has a concave radius of curvature and the paired outer rolling member track radius of curvature has a convex radius of curvature.

2. The constant velocity joint of claim 1, wherein every other inner rolling member track radius of curvature has a convex radius of curvature, with the paired outer rolling member track radius of curvature having a concave radius of curvature, and every other inner rolling member track radius of curvature has a concave radius of curvature, with the paired outer rolling member track radius of curvature having a convex radius of curvature.

3. The constant velocity joint of claim 1, wherein every other inner rolling member track has a left helix about the central axis of rotation, with the outer rolling member tracks paired with the left helix inner rolling member tracks having a right helix about the central axis of rotation, and every other inner rolling member track has a right helix about the central axis of rotation, with the outer rolling member tracks paired with the right helix inner rolling member tracks having a left helix about the central axis of rotation.

4. The constant velocity joint of claim 3, wherein every other inner rolling member track radius of curvature has a convex radius of curvature, with the corresponding outer rolling member track radius of curvature paired with the convex radius of curvature having a concave radius of curvature, and every other inner rolling member track radius of curvature has a concave radius of curvature, with the corresponding outer rolling member track radius of curvature paired with the concave radius of curvature having a convex radius of curvature.

5. The constant velocity joint of claim 1, wherein the constant velocity joint is a stroking joint allowing relative axial movement between the inner race and the outer race along the central axis of rotation.

6. The constant velocity joint of claim 1, wherein the inner rolling member track radius of curvature is not constant.

7. The constant velocity joint of claim 6, wherein the outer rolling member track radius of curvature is not constant.

8. The constant velocity joint of claim 7, wherein the inner rolling member track radius of curvature and the outer rolling member track radius of curvature are equidistantly spaced from one another along their entirety.

9. The constant velocity joint of claim 1, wherein at least one of the inner rolling member track radius of curvature and the outer rolling member track radius of curvature has an origin of radius offset from the central axis of rotation.

10. A constant velocity joint, comprising:
an inner race having opposite inner race sides with a plurality of inner rolling member tracks following an inner rolling member track helical path relative to the central axis of rotation, each inner rolling member track having an inner rolling member track radius of curvature extending from one of the inner race sides to the other of the inner race sides;
an outer race disposed about the inner race such that the inner race and the outer race extend about a common central axis of rotation, the outer race having opposite outer race sides with a plurality of outer rolling member tracks following an outer rolling member track helical path relative to the central axis of rotation, each outer rolling member track having an outer rolling member track radius of curvature extending from one of the outer race sides to the other of the outer race sides, the outer rolling member tracks being arranged in paired relation with the inner rolling member tracks to define a plurality of rolling member raceways; and
at least one rolling member disposed in each of the rolling member raceways for rolling receipt in the inner rolling member tracks and the outer rolling member tracks,
wherein the inner rolling member track radius of curvature of at least one of the inner rolling member tracks has an origin of radius offset from the central axis of rotation.

11. The constant velocity joint of claim 10, wherein the central axis of rotation is between the origin of radius of at least one inner rolling member track and a corresponding inner rolling member track.

12. The constant velocity joint of claim 11, wherein each inner rolling member track radius of curvature is convex.

13. The constant velocity joint of claim 11, wherein at least one inner rolling member track is between a corresponding origin of radius thereof and the central axis of rotation.

14. The constant velocity joint of claim 13, wherein at least one inner rolling member track radius of curvature is convex and at least one inner rolling member track radius of curvature is concave.

15. The constant velocity joint of claim 14, wherein every other inner rolling member track radius of curvature is convex, with the paired outer rolling member track radius of curvature being concave, and every other inner rolling member track radius of curvature is concave, with the paired outer rolling member track radius of curvature being convex.

16. The constant velocity joint of claim 10, wherein at least one inner rolling member track is between a corresponding origin of radius thereof and the central axis of rotation.

17. The constant velocity joint of claim 16, wherein each inner rolling member track radius of curvature is concave or convex.

18. The constant velocity joint of claim 10, wherein the outer rolling member track radius of curvature of at least one of the outer rolling member tracks has an origin of radius offset from the central axis of rotation.

19. The constant velocity joint of claim 18, wherein the central axis of rotation is between the origin of radius of at least one outer rolling member track and a corresponding outer rolling member track.

20. The constant velocity joint of claim 19, wherein at least one outer rolling member track is between a corresponding origin of radius thereof and the central axis of rotation.
